(19) United States
(12) Patent Application Publication
(10) Pub. No.: US 2026/0288125 A1
(43) Pub. Date: Sep. 24, 2026

(54) METHODS AND MECHANISMS FOR USING MACHINE LEARNING TO GENERATE PRODUCTION CONTROL SCENARIOS

(71) Applicant: Applied Materials, Inc., Santa Clara, CA (US)

(72) Inventors: David Everton Norman, Bountiful, UT (US); Paul Hoad, Fleet (GB)

(21) Appl. No.: 19/088,015

(22) Filed: Mar. 24, 2025

(51) Int. Cl. G05B 19/418

(52) U.S. Cl. CPC G05B 19/41885; G05B 2219/23123

(57) ABSTRACT

A system configured to receive, by a processing device, a query related to a desired production scenario of a substrate fabrication facility and generate a prompt based on the query. The prompt comprises data related to the query and data related to one or more data structures used by a production model to generate production scenario options. The prompt is provided as input to a trained machine learning model and an output of the trained machine learning model is obtained. The output comprises modification data associated with the one or more data structures to be used by the production model to generate the desired production scenario.

### TECHNICAL FIELD

The present disclosure relates to methods and mechanisms for using machine learning to generate production control scenarios.

### BACKGROUND

Products can be produced by performing one or more manufacturing processes using manufacturing equipment. For example, semiconductor manufacturing equipment can be used to produce substrate (e.g., semiconductor wafers) via semiconductor manufacturing processes. The manufacturing equipment can, according to a process recipe and via a substrate processing tool, deposit multiple layers of film on the surface of the substrate and can perform an etch process to form the intricate pattern in the deposited film. Sensors can be used to determine manufacturing parameters of the manufacturing equipment during the manufacturing processes and metrology equipment can be used to determine property data of the products that were produced by the manufacturing equipment, such as the overall thickness of the layers on the substrate.

### SUMMARY

The following is a simplified summary of the disclosure in order to provide a basic understanding of some aspects of the disclosure. This summary is not an extensive overview of the disclosure. It is intended to neither identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

In an aspect of the disclosure, a system is configured to receive a query related to a desired production scenario of a substrate fabrication facility and generate a prompt based on the query. The prompt comprises data related to the query and data related to one or more data structures used by a production model to generate production scenario options. The prompt is provided as input to a trained machine learning model and an output of the trained machine learning model is obtained. The output comprises modification data associated with the one or more data structures to be used by the production model to generate the desired production scenario.

A further aspect of the disclosure includes a method according to any aspect or implementation described herein.

A further aspect of the disclosure includes a non-transitory computer-readable storage medium comprising instructions that, when executed by a processing device operatively coupled to a memory, performs operations according to any aspect or implementation described herein.

### BRIEF DESCRIPTION OF THE DRAWINGS

The present disclosure is illustrated by way of example, and not by way of limitation in the figures of the accompanying drawings.

FIG. 1 is a block diagram illustrating an production environment, in accordance with some implementations of the present disclosure.

FIG. 2 is a top schematic view of an example manufacturing system, in accordance with some implementations of the present disclosure.

FIG. 3 is a block diagram illustrating an example predictive architecture, in accordance with some implementations of the present disclosure.

FIGS. 4A-4C are diagrams of frameworks for applying a machine learning model to generate predictive data, in accordance with some implementations of the present disclosure.

FIG. 5 is a flow diagram of method for applying a machine learning model to generate predictive data, in accordance with some implementations of the present disclosure.

FIG. 6 is a block diagram illustrating a computer system, according to certain implementations.

### DETAILED DESCRIPTION

Described herein are technologies directed to methods and mechanisms for using machine learning to generate production control scenarios. A dispatching system of a substrate fabrication facility can be used to make dispatch decisions that control operation of processing tools of the fabrication facility. Manufacturing equipment of the substrate fabrication facility can include multiple substrate processing tools where each tool can have one or more processing chambers. A processing chamber can have multiple sub-systems operating during each substrate manufacturing process (e.g., the deposition process, the etch process, the polishing process, etc.). A sub-system can be characterized as a set of sensors and controls related with an operational parameter of the processing chamber. An operational parameter can be a temperature, a flow rate, a pressure, and so forth. In an example, a pressure sub-system can be characterized by one or more sensors measuring the gas flow, the chamber pressure, the control valve angle, the foreline (vacuum line between pumps) pressure, the pump speed, and so forth. Accordingly, the processing chamber can include a pressure sub-system, a flow sub-system, a temperature subsystem, and so forth. A processing chamber can perform a manufacturing process according to a process recipe. A process recipe defines a particular set of operations to be performed for the substrate during the process and can include one or more settings associated with each operation. A process recipe can be embodied as a table of recipe settings including a set of inputs or recipe parameters (“parameters”) and processes that are manually entered by a user (e.g., process engineer) to achieve a set of target properties (e.g., on-substrate characteristics), also referred to as a set of goals. For example, a deposition process recipe can include a temperature setting for the processing chamber, a pressure setting for the processing chamber, a flow rate setting for a precursor for a material included in the film deposited on the substrate surface, etc. Accordingly, the thickness of each film layer, the depth of each etch, and so forth, can be correlated to these processing chamber settings.

A dispatching system can make dispatch decisions to improve manufacturing productivity. For example, a dispatching system for a substrate fabrication facility can be used to make dispatch decisions to improve manufacturing productivity across multiple substrate processing tools of the substrate fabrication facility. An example of the dispatching system is a real-time dispatching (RTD) system that makes dispatch decisions in real-time or near real-time. Dispatching systems can enable substrate manufacturers to develop dispatching policies to optimally fabricate various substrates with minimal performance bottleneck across the substrate processing tools. For example, a dispatching system can use a manufacturing execution system (MES) when making dispatching decisions, either by querying the MES database or by replicating the MES data into the dispatching system. The MES can be communicably coupled to a set of substrate processing tools and can gather raw facility data from various components of the substrate fabrication facility, such as a set of processing tools, and store the raw facility data in an MES database, which can be a relational database, for example.

The dispatching system can further include a data processing component to process the raw facility data to generate processed facility data, also referred to as state data. The dispatching system can further include a repository that can store the state data. The state data can be used by the dispatching system to coordinate and optimize substrate processing tasks to meet production goals. For example, the state data can be used to track individuals lots and substrates (e.g., wafers) throughout substrate fabrication, manage process recipes used by substrate processing tools to fabricate substrates, monitor the status of the substrate processing tools, perform yield management to improve overall yield of the substrate fabrication facility, etc.

More specifically, the dispatching system can further include a set of dispatchers. A dispatcher is a software application that manages the scheduling and execution of tasks performed by processing tools in a fabrication facility. For example, a task can be a substrate process performed by a substrate processing tool of a substrate fabrication facility. In a fabrication facility, there can be multiple processing tools and multiple lots that may need to be processed at the same time. Thus, the set of dispatchers can include multiple dispatchers in order to concurrently handle multiple dispatching requests received at approximately the same time. For example, a dispatcher can optimize resource utilization, prioritize tasks, determine tasks execution order to maximize throughput, distribute workload across processing tools to optimize efficiency (e.g., load balancing), monitor a state of the substrate fabrication facility, etc. In particular, a dispatcher can make dispatch decisions regarding task scheduling and execution to optimize task execution (e.g., improve throughput). A dispatch decision defines an action that should happen next in the manufacturing facility. For example, a dispatch decision can select a processing tool into which a substrate should be placed for processing. Examples of dispatch decisions that can be performed in a substrate fabrication facility can include “where a substrate lot should be processed next,” “which substrate lot should be picked for an idle substrate processing tool,” etc. The state of a substrate fabrication facility can include status of the substrate processing tools, status of the substrates (e.g., locations and/or processing states of substrates), status of processing tasks being performed by the substrate processing tools, etc.

To make dispatch decisions, a dispatcher can utilize an in-memory rule execution engine that processes a set of dispatch rules based on dispatch decision data. For example, dispatch decision data can include facility data related to the substrate fabrication facility. Dispatch decision data can include data reflecting a state of the substrate fabrication facility and/or factors that can affect dispatching (e.g., task scheduling and execution among the substrate processing tools). Examples of dispatch decision data can include, for example, lot information, substrate processing tool information (e.g., substrate processing tool capability and/or availability), route information, process recipe information, production goals, etc. Examples of dispatch rules can include, and are not limited to, select the highest priority substrate lot to work on next, select a substrate lot that uses the same set up which the tool is currently configured for, package items when a purchase order is complete, ship items when packaging is complete, etc. For example, the dispatch decision to be made may be “where a substrate lot should be processed next,” and the dispatch rule that may be used to make the decision may be to “select the highest priority substrate lot to work on next and select a substrate lot that uses the same set up which the substrate processing tool is currently configured for.”

The dispatcher can generate a task schedule for weeks into the future. In some instances, this task schedule can reveal certain upcoming issues, such as avoidable conflicts, inefficient scheduling, etc. In other instances, a user may wish to add certain items to the schedule, such as, for example, one or more maintenance events (e.g., schedule a preventive maintenance cleaning to prevent possible equipment failures). Accordingly, a production simulation model and/or a production planning model can be used to simulate certain production scenarios. For example, the production simulation model can be used to generate a hypothetical task schedule that include an added maintenance event, a change to the scheduled tasks, and so forth while the production planning model can be used to determine how long each tool will be in use during a production scenario. Typically, these production models utilize dozens of data tables with a specified schema, each table including dozens of columns for specific data. In particular, each table can reflect different aspects of the substrate fabrication facility (e.g., process flows, processing times, sampling plans, equipment and equipment qualifications, etc.), of factor states (e.g., current and including work in progress (WIP), equipment states, etc.), and so forth. As such, to simulate specific production scenarios, a user would need to understand and remember the schema of the simulation and planning models to know which records in the tables need to be changed which can be a burdensome and error-prone endeavor.

Aspects and implementations of the present disclosure address these and other shortcomings of the existing technology by using machine learning to generate production control scenarios. In particular, the system of the present disclosure can receive a query related to a production scenario. In an illustrative example, the query, received via user input, can indicate a request for information on how to create a scenario where the preventive maintenance for process chamber A is moved from date A to date B, how to create a bar graph with on-time delivery of the lots for a scenario, etc. The system can then access one or more data structures such as data tables related to a production model (e.g., a simulation model, a planning model) and generate a prompt that includes the query(ies) and the data structures. For example, the system can automatically insert the questions and/or statements of the query and references to the data structures into a predetermined format. The prompt can be provided to a machine learning model such as, for example, a large language model (LLM) designed to understand and generate human-like text. The LLM can generate, as output, a modification report, modification instructions, a comparison report, etc. In some implementations, the modification report can include data reflecting one or more operations (e.g., steps) describing how to modify one or more structures to produce a desired scenario via a simulation model and/or a planning model. In some implementations, the modification report can include steps describing how to produce a graph, chart, or table, that compares a scenario with a different scenario or with the current scheduled production of the substrate fabrication facility. Modification instructions can include data reflecting instructions (e.g., computer code) to modify one or more tables to produce the desired scenario via the simulation model and/or the planning model, instructions to produce comparison data, etc. In some implementations, the modification instructions can automatically be executed to generate, via a production model, the desired scenario. A comparison report can include comparison data, such as, for example, a graph, table, and/or a chart illustrating comparisons or differences between two or more sets of data (e.g., production scenarios, the current production schedule, etc.).

Aspects and implementations of the present disclosure address the shortcomings of the existing technology by providing techniques for automatically generating or providing specific instructions to generate desired production control scenarios. This allows the users of the substrate fabrication facility to quickly and efficiently generate these desired scenarios and/or compare different scenarios to improve the production efficiency of the substrate fabrication facility, thus saving considerable costs and production time.

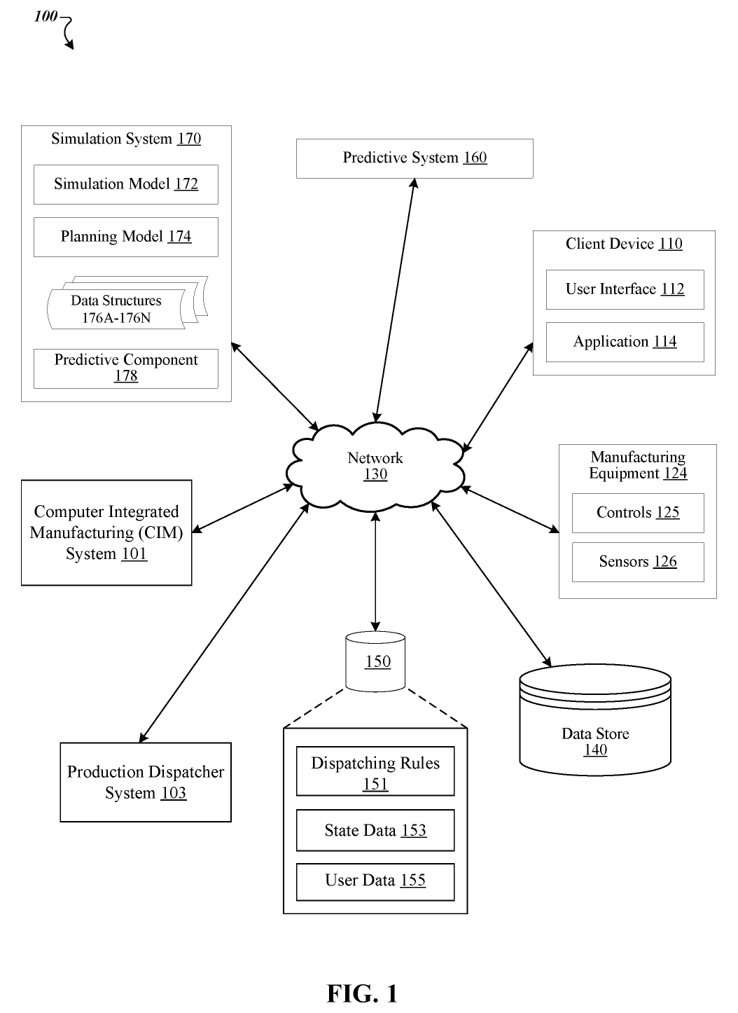

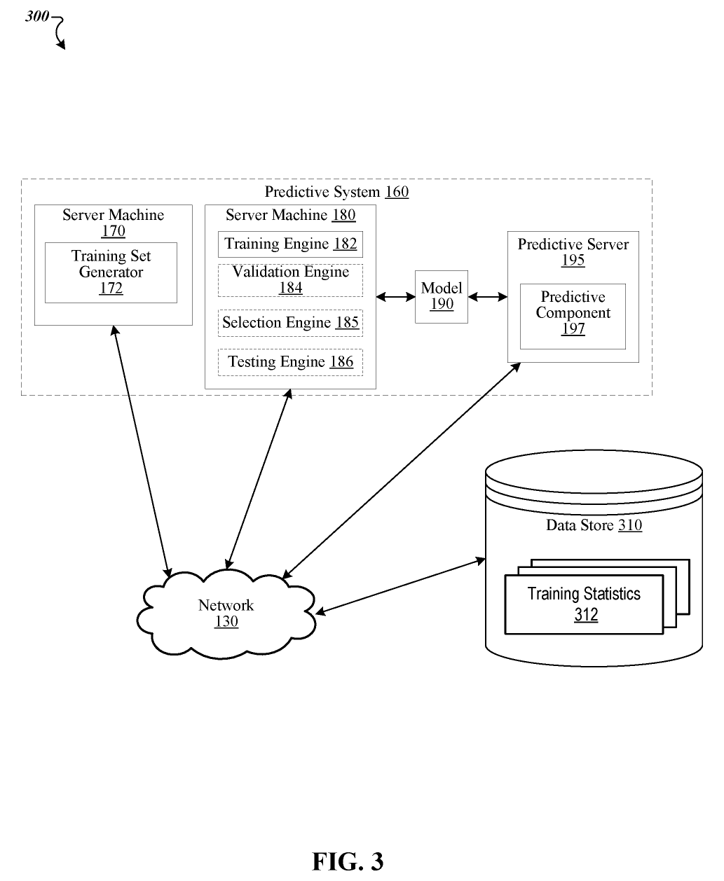

FIG. 1 is a block diagram illustrating a production environment 100, according to aspects of the present disclosure. A production environment 100 can include multiple systems, such as, and not limited to, a production dispatcher system 103, manufacturing equipment 124 (e.g., manufacturing tools, automated devices, etc.), client device 110, a simulation system 170 (e.g., to generate predictive data such as dispatching decisions), predictive system 160 (e.g., to generate predictive data, to provide model adaptation and modification, to use a knowledge base, etc., which will be described in detail in FIG. 3), and one or more computer integrated manufacturing (CIM) systems 101. Examples of CIM systems 101 can include, and are not limited to, a manufacturing execution system (MES), enterprise resource planning (ERP), production planning and control (PPC), computer-aided systems (e.g., design, engineering, manufacturing, processing planning, quality assurance), computer numerical controlled machine tools, direct numerical control machine tools, controllers, etc. Examples of a production environment 100 can include, and are not limited to, a manufacturing plant, a fulfillment center, etc. For brevity and simplicity, a substrate fabrication facility is used as an example of a production environment 100 throughout this description.

In some implementations, production environment 100 can be a substrate fabrication facility. In such implementations, manufacturing equipment 124 can perform multiple different operations related to the fabrication of substrates, such as, for example, semiconductor wafers. For example, manufacturing equipment 124 can be substrate processing tools that perform cutting operations, cleaning operations, deposition operations, etching operations, testing operations, and so forth. Aspects of the present disclosure are described with regard to fabrication of semiconductor substrates in a semiconductor manufacturing environment. However, it should be noted that implementations of the present disclosure can be applied to other production environments 100 configured to fabricate or otherwise process lots different from semiconductor substrates. A lot can refer to a set of substrates.

Manufacturing equipment 124 can produce products, such as electronic devices, following a recipe or performing runs over a period of time. Manufacturing equipment 124 can include a process chamber. Manufacturing equipment 124 can perform a process for a substrate (e.g., a wafer, etc.) at the process chamber. Examples of substrate processes include a deposition process to deposit one or more layers of film on a surface of the substrate, an etch process to form a pattern on the surface of the substrate, etc. Manufacturing equipment 124 can perform each process according to a process recipe. A process recipe defines a particular set of operations to be performed for the substrate during the process and can include one or more settings associated with each operation. For example, a deposition process recipe can include a temperature setting for the process chamber, a pressure setting for the process chamber, a flow rate setting for a precursor for a material included in the film deposited on the substrate surface, etc.

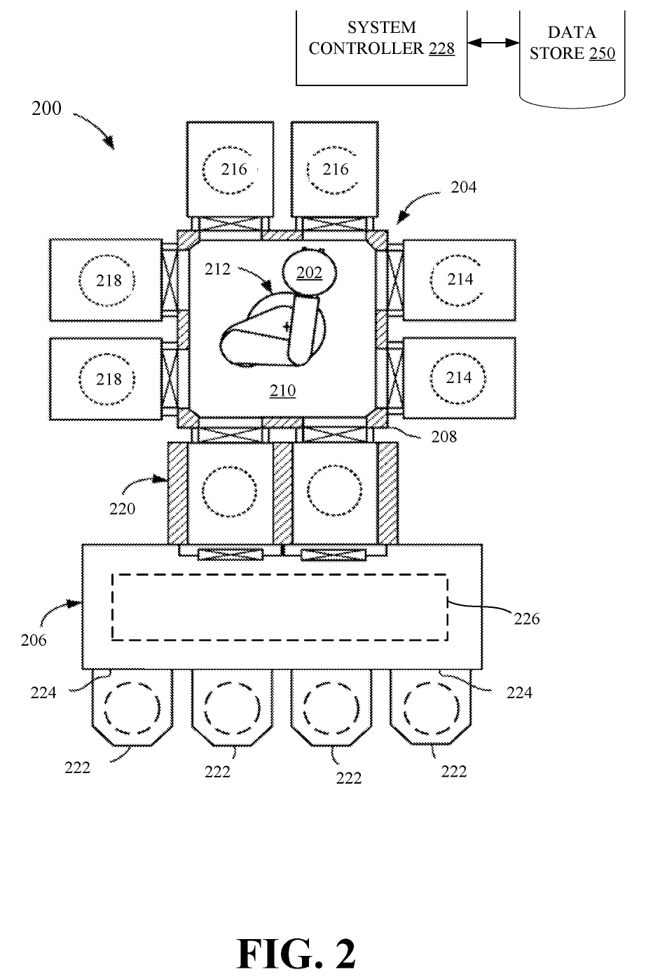

In some implementations, manufacturing equipment 124 includes sensors 126 that are configured to generate data associated with a substrate processed at manufacturing system 100. For example, a process chamber can include one or more sensors configured to generate spectral or non-spectral data associated with the substrate before, during, and/or after a process (e.g., a deposition process, an etch process, etc.) is performed for the substrate. In some implementations, spectral data generated by sensors 126 can indicate a concentration of one or more materials deposited on a surface of a substrate. Sensors 126 configured to generate spectral data associated with a substrate can include reflectometry sensors, ellipsometry sensors, thermal spectra sensors, capacitive sensors, and so forth. Sensors 126 configured to generate non-spectral data associated with a substrate can include temperature sensors, pressure sensors, flow rate sensors, voltage sensors, etc. For example, each sensor 126 can be a temperature sensor, a pressure sensor, a chemical detection sensor, a chemical composition sensor, a gas flow sensor, a motion sensor, a position sensor, an optical sensor, or any and other type of sensors. Some or all of the sensors 126 can include a light source to produce light (or any other electromagnetic radiation), direct it towards a target, such as a component of the machine 100 or a substrate, a film deposited on the substrate, etc., and detect light reflected from the target. The sensors 126 can be located anywhere inside the manufacturing equipment 124 (for example, within any of the chambers including the loading stations, on one or more robots, on a robot blade, between the chambers, and so one), or even outside the manufacturing equipment 124 (where the sensors can test ambient temperature, pressure, gas concentration, and so on). Further details regarding manufacturing equipment 124 are provided with respect to FIG. 2.

In some implementations, the manufacturing equipment 124 and sensors 126 can be part of a sensor system that includes a sensor server (e.g., field service server (FSS) at a manufacturing facility) and sensor identifier reader (e.g., front opening unified pod (FOUP) radio frequency identification (RFID) reader for sensor system). In some implementations, manufacturing equipment 124 can include, or be operationally coupled to, metrology equipment (not shown) that includes a metrology server (e.g., a metrology database, metrology folders, etc.) and metrology identifier reader (e.g., FOUP RFID reader for metrology system)

In some implementations, sensors 126 provide sensor data (e.g., sensor values, features, trace data) associated with manufacturing equipment 124 (e.g., associated with producing, by manufacturing equipment 124, corresponding products, such as substrates). The manufacturing equipment 124 can produce products following a recipe or by performing runs over a period of time. Sensor data received over a period of time (e.g., corresponding to at least part of a recipe or run) can be referred to as trace data (e.g., historical trace data, current trace data, etc.) received from different sensors 126 over time. Sensor data can include a value of one or more of temperature (e.g., heater temperature), spacing (SP), pressure, high frequency radio frequency (HFRF), voltage of electrostatic chuck (ESC), electrical current, material flow, power, voltage, etc. Sensor data can be associated with or indicative of manufacturing parameters such as hardware parameters, such as settings or components (e.g., size, type, etc.) of the manufacturing equipment 124, or process parameters of the manufacturing equipment 124. The sensor data can be provided while the manufacturing equipment 124 is performing manufacturing processes (e.g., equipment readings when processing products). The sensor data can be different for each substrate.

In some implementations, manufacturing equipment 124 can include controls 125. Controls 125 can include one or more components or sub-systems configured to enable and/or control one or more processes of manufacturing equipment 124. For example, a sub-system can include a pressure sub-system, a flow sub-system, a temperature sub-system and so forth, each sub-system having one or more components. The component can include, for example, a pressure pump, a vacuum, a gas deliver line, a plasma etcher, actuators etc. In some implementations, controls 125 can be managed based on data from sensors 126.

In some implementations, certain sensors 126 and controls 125 can be related to one or more control modules. In particular, each control module can include a set of sensors 126, controls 125, control logic regulating the sensors and/or components, etc. In an illustrative example, the controls modules can include a thermal control module, a plasma control module, a reactant flux control module, and a substrate control module. The thermal control module can include sensors and controls related to providing and maintain a heating environment in a process chamber (e.g., heater, heater sensor, etc.). The plasma control module can include sensors and controls related to creating or adjusting a plasma environment in a process chamber (e.g., plasma etcher, etcher sensor, etc.). The reactant flux control module can include sensors and controls related to the gas flow operations in a process chamber (e.g., gas flow control and sensor, pump, etc.). The substrate control module can include sensors and controls related to substrate properties (e.g., warp experience by a substrate). In certain implementations, sensor data from one or more of the particular control modules can be processed and analyzed, via modules 151-153 and the methods discussed herein, to control the respective operating conditions (e.g., a parameter of a process recipe) associated with said process control module.

The CIM 101, production dispatcher system 103 manufacturing equipment 124, client device 110, predictive system 160, simulation system 170, and data stores 140, 150 can be coupled to each other via network 130. Network 130 can include one or more wide area networks (WANs), local area networks (LANs), wired networks (e.g., Ethernet network), wireless networks (e.g., an 802.11 network or a Wi-Fi network), cellular networks (e.g., a Long-Term Evolution (LTE) network), routers, hubs, switches, server computers, cloud computing networks, and/or a combination thereof. The CIM system 101, production dispatcher system 103, and predictive system 160 can be individually hosted or hosted in any combination together by any type of machine including server computers, gateway computers, desktop computers, laptop computers, tablet computers, notebook computers, PDAs (personal digital assistants), mobile communication devices, cell phones, smart phones, hand-held computers, or similar computing devices. In some implementations, predictive system 160 is part of a server that is hosted on a machine.

Data stores 140, 150 can be a memory (e.g., random access memory), a drive (e.g., a hard drive, a flash drive), a database system, or another type of component or device capable of storing data. Data stores 140, 150 can include multiple storage components (e.g., multiple drives or multiple databases) that can span multiple computing devices (e.g., multiple server computers).

Data store 140 can store data associated with processing a substrate at manufacturing equipment 124. For example, data store 140 can store data collected by sensors 126 at manufacturing equipment 124 before, during, or after a substrate process (referred to as process data). Process data can refer to historical process data (e.g., process data generated for a prior substrate processed at the fabrication facility) and/or current process data (e.g., process data generated for a current substrate processed at the fabrication facility). Data store can also store spectral data or non-spectral data associated with a portion of a substrate processed at manufacturing equipment 124. Spectral data can include historical spectral data and/or current spectral data.

Data store 140 can also store contextual data associated with one or more substrates processed at the fabrication facility. Contextual data can include a recipe name, recipe step number, preventive maintenance indicator, operator, etc. Contextual data can refer to historical contextual data (e.g., contextual data associated with a prior process performed for a prior substrate) and/or current process data (e.g., contextual data associated with current process or a future process to be performed for a prior substrate). The contextual data can further include identify sensors that are associated with a particular sub-system of a process chamber.

Data store 140 can also store task data. Task data can include one or more sets of operations to be performed for the substrate during a deposition process and can include one or more settings associated with each operation. For example, task data for a deposition process can include a temperature setting for a process chamber, a pressure setting for a process chamber, a flow rate setting for a precursor for a material of a film deposited on a substrate, etc. In another example, task data can include controlling pressure at a defined pressure point for the flow value. Task data can refer to historical task data (e.g., task data associated with a prior process performed for a prior substrate) and/or current task data (e.g., task data associated with current process or a future process to be performed for a substrate).

In some implementations, data store 140 can be configured to store data that is not accessible to a user of the fabrication facility. For example, process data, spectral data, contextual data, etc. obtained for a substrate being processed at the fabrication facility is not accessible to a user (e.g., an operator) of the fabrication facility. In some implementations, all data stored at data store 140 can be inaccessible by the user of the fabrication facility. In other or similar implementations, a portion of data stored at data store 140 can be inaccessible by the user while another portion of data stored at data store 140 can be accessible by the user. In some implementations, one or more portions of data stored at data store 140 can be encrypted using an encryption mechanism that is unknown to the user (e.g., data is encrypted using a private encryption key). In other or similar implementations, data store 140 can include multiple data stores where data that is inaccessible to the user is stored in one or more first data stores and data that is accessible to the user is stored in one or more second data stores.

Data store 150 dispatching rules 151, state data 153, and user data 155. Dispatching rules 151 can be logic that can be executed by the production dispatcher system 103. In some implementations, dispatching rules 151 can be user (e.g., industrial engineer, process engineer, system engineer, etc.) defined. Examples of dispatching rules 151 can include, and are not limited to, select the highest priority substrate to work on next, select a substrate that uses the same set up which the tool is currently configured for, package items when a purchase order is complete, ship items when packaging is complete, etc. The individual dispatching rules 151 can be associated with a large number of data processes to implement the corresponding dispatching rule 151. Examples of data processes can include, and are not limited to import data, compress data, index data, filter data, perform a mathematical function on data, etc.

State data 153 can include a state of manufacturing equipment 124 (e.g., an operating temperature, an operating pressure, a number of substrates being processed at the manufacturing equipment, a number of substrates in a manufacturing equipment queue at a particular instance of time, current service life, setup data, a set of operations that include individual processes performed at one or more manufacturing facilities of a production environment, etc.). State data 153 can be generated by manufacturing equipment 124 during operation of production environment 100 and stored at data store 150. State data 153 can include one or more of current state data, historical state data, and perturbed state data. Current state data can include data relating to the current state of manufacturing equipment 124 (e.g., current operating temperature, current operating pressure, current number of substrates being processed at the manufacturing equipment, etc.). Historical state data can include data relating to a past state of manufacturing equipment 124 (e.g., past operating temperature at a particular instance of time, past operating pressure at a particular instance of time, past number of substrates being processed at the manufacturing equipment at a particular instance of time, etc.). Perturbed state data can include modified state data. In particular, perturbed state data can include current or historical state data that has had one or more parameters modified or distorted. The one or more parameters can be modified based on user input, a certain percentage, a certain value, randomly modified, etc. For example, perturbed state data can include a past number of substrates being processed at the manufacturing equipment at a particular instance of time reduced or increased by a predetermined value of two substrates. In another example, perturbed state data can include a past number of substrates sets being processed at the manufacturing equipment at a particular instance of time reduced or increased by a random number of sets between, for example, one and ten. In some implementations, state data 153 can include, or be generated from, the data stored in data store 140. For example, state data 153 can include, or be generated from, sensor data, contextual data, task data, etc.

User data 155 can include data provided by a user of production environment 100 (e.g., an operator, a process engineer, industrial engineer, system engineer, etc.). In some implementations, user data 155 can be provided via client device 110.

The client device 110 can include a computing device such as personal computers (PCs), laptops, mobile phones, smart phones, tablet computers, netbook computers, network connected televisions (“smart TVs”), network-connected media players (e.g., Blu-ray player), a set-top box, over-the-top (OTT) streaming devices, operator boxes, etc. Client device 110 can display a user interface 112, such as a graphical user interface, and application 114. In some implementations, client device 110 can provide, for display on user interface 112, input data (e.g., a prompt, one or more questions, commands, etc.), predictive output data (e.g., data from predictive system 160, such as, for example, a modification report, modification instructions, a comparison report, etc.), server data (e.g., any data generated and/or provided by a server device), or any other data items. In some implementations, user interface 112 can enable the user to provide the input data. In some implementations, user interface 112 can be presented via a web browser (not shown) and application 114 can be hosted on an application server (not shown). Alternatively, the client device 110 includes a local (mobile or desktop) application 114 that provides user interface 112. In some implementations, user interface 112 can communicate with the application 114 via network 130. In some implementations, input data (e.g., prompt data, etc.) can be sent to or processed by application 114. Each client device 110 can include an operating system that allows users to generate, view, or edit data (e.g., indication associated with manufacturing equipment 124, corrective actions associated with manufacturing equipment 124, etc.).

Application 114 can be a computer program configured to provide instructions, simulation technologies, and predictive technologies performed by one or more of predictive system 160 and/or simulation system 170. In some implementations, to generate output data (e.g., a modification report, modification instructions, a comparison report, etc.), predictive system 160 can use one or more large language models (LLM) and/or any other type of machine language models trained to perform natural language processing tasks. A modification report can include data reflecting one or more steps describing how to modify one or more structures 176A-176N to produce a desired scenario via simulation model 172 and/or planning model 174, how to produce comparison data (e.g., steps describing how to manipulate output data to produce a graph, chart, or table), etc. Modification instructions can include data reflecting instructions (e.g., computer code) to modify one or more structures 176A-176N to produce a desired scenario, via simulation model 172 and/or planning model 174, instructions to produce comparison data, etc. A comparison report can include comparison data, such as, for example, a graph, table, and/or a chart illustrating comparisons or differences between two or more sets of data. In an illustrative example, the comparison data can include a bar graph showing on-time delivery of all of the lots for each scenario and for the current task schedule.

Simulation system 170 can include one or more production models (e.g., a predictive system, a software agent or intelligent agent, a mathematical model, etc.) configured to simulate certain production scenarios. In particular, simulation system 170 can include simulation model 172 that is configured to generate a scenario reflecting a detailed moving of lots through production environment 100 and planning model 174 that is configured to determine how long each tool will be in use during a production scenario. Simulation system 170 can further include structures 176A-176N and predictive component 178.

In some implementations, simulation model 172 and/or planning model 174 can be trained using reinforcement learning, deep reinforcement learning, etc. Reinforcement learning is a class of algorithms applicable to sequential decision-making tasks. In particular, reinforcement learning is a process in which a software agent learns to make decisions through trial and error. In some implementations, training the software agent can include using deep reinforcement learning. Deep reinforcement learning combines artificial neural networks with a framework of reinforcement learning (e.g., learning from trial and error) that helps software agents learn how to reach their goals. In particular, deep reinforcement learning unites function approximation and target optimization, mapping states and actions to the rewards they lead to. In an implementation, the Proximal Policy Optimization (PPO) algorithm can be used to train a software agent. The PPO algorithm is a deep RL algorithm which uses a policy gradient method to train a stochastic policy in an on-policy way. The PPO algorithm also utilizes the actor critic method.

Simulation model 172 and planning model 174 can use one or more structures 176A-176N to simulate a production environment and generate a predictive production scenario. For example, simulation model 172 can generate a hypothetical task schedule that includes a set of dispatching decisions and planning model 174 can generate a hypothetical listing of how long each tool will be in use during a production scenario. In an illustrative example, the data structure can be a data table where each table can include a set of records organized in one or more columns and one or more rows. Each record can store data indicative of one or more aspects of a production environment 100.

Simulation system 170 can also include a predictive component 178 that is capable of running simulation model 172 and/or planning model 174 on current state data and providing predicative data indicative of a predictive production scenario and/or predictive utilization report. Predictive component 178 can be executed on a server which can include one or more computing devices such as a rackmount server, a router computer, a server computer, a personal computer, a mainframe computer, a laptop computer, a tablet computer, a desktop computer, Graphics Processing Unit (GPU), accelerator Application-Specific Integrated Circuit (ASIC) (e.g., Tensor Processing Unit (TPU)), etc.

In general, functions described in one implementation as being performed by a server machine, simulation system 170, and/or predictive system 160 can also be performed on client device 110. In addition, the functionality attributed to a particular component can be performed by different or multiple components operating together.

In implementations, a “user” can be represented as a single individual. However, other implementations of the disclosure encompass a “user” being an entity controlled by a plurality of users and/or an automated source. For example, a set of individual users federated as a group of administrators can be considered a “user.”

The production dispatcher system 103 can make dispatching decisions for the production environment 100. A dispatching decision decides what action should be performed at a given time in the production environment 100. Dispatching often involves decisions such as whether the start processing a batch, whether to start processing a batch that has fewer substrates than allowed or wait to start the batch until additional substrates are available so a full batch can be started, etc. Examples of dispatching decisions can include, and are not limited to, where a substrate should be processed next in the production environment, which substrate should be picked for an idle piece of equipment in the production environment, and so forth. In some implementations, the production dispatcher system 103 can use the predictive data generated by the predictive component 174 (e.g., the dispatching parameters and/or dispatching order) to make a dispatching decision. In some implementations, the production dispatcher system 103 can use one or more dispatching rules 151 that are stored in the data store 150 to make a dispatching decision.

In some instances, manufacturing processes can include of hundreds of operations performed by manufacturing equipment 124 (e.g., tools or automated devices) within the production environment 100. In many instances, one or more operations can be subjected to a time constraint. As discussed previously, a time constraint refers to a particular amount of time after an operation is completed that a subsequent operation is to be completed. For example, after a first material is deposited on a surface of a substrate, a second material is to be deposited on the first material within a particular amount of time after the deposition of the first material. If the second coating is not deposited on the first material within the particular amount of time, the first material can begin to degrade, leaving the substrate unusable. A time constraint window refers to an amount of time to complete a first operation (referred to as an initiating operation) and the particular amount of time a second operation (referred to as a completion operation) is to be completed. In some implementations, one or more operations performed between the initiating operation and the completion operation are also associated with the time constraint window. In accordance with the previous example, a time constraint window can refer to a first amount of time to deposit the first material on the surface of the substrate and the particular amount of time in which the second material is to be deposited on the first material. Multiple operations can be subject to one or more time constraints. In some implementations, a completion operation for a first time constraint window can also be an initiating operation for a second time constraint window.

FIG. 2 is a top schematic view of an example manufacturing system 200, according to aspects of the present disclosure. Manufacturing system 200 can perform one or more processes on a substrate 202. Substrate 202 can be any suitably rigid, fixed-dimension, planar article, such as, e.g., a silicon-containing disc or wafer, a patterned wafer, a glass plate, or the like, suitable for fabricating electronic devices or circuit components thereon.

Manufacturing system 200 can include a process tool 204 and a factory interface 206 coupled to process tool 204. Process tool 204 can include a housing 208 having a transfer chamber 210 therein. Transfer chamber 210 can include one or more process chambers (also referred to as processing chambers) 214, 216, 218 disposed therearound and coupled thereto. Process chambers 214, 216, 218 can be coupled to transfer chamber 210 through respective ports, such as slit valves or the like. Transfer chamber 210 can also include a transfer chamber robot 212 configured to transfer substrate 202 between process chambers 214, 216, 218, load lock 220, etc. Transfer chamber robot 212 can include one or multiple arms where each arm includes one or more end effectors at the end of each arm. The end effector can be configured to handle particular objects, such as wafers, sensor discs, sensor tools, etc.

Process chambers 214, 216, 218 can be adapted to carry out any number of processes on substrates 202. A same or different substrate process can take place in each processing chamber 214, 216, 218. A substrate process can include atomic layer deposition (ALD), physical vapor deposition (PVD), chemical vapor deposition (CVD), etching, annealing, curing, pre-cleaning, metal or metal oxide removal, or the like. Other processes can be carried out on substrates therein. Process chambers 214, 216, 218 can each include one or more sensors configured to capture data for substrate 202 before, after, or during a substrate process. For example, the one or more sensors can be configured to capture spectral data and/or non-spectral data for a portion of substrate 202 during a substrate process. In other or similar implementations, the one or more sensors can be configured to capture data associated with the environment within process chamber 214, 216, 218 before, after, or during the substrate process. For example, the one or more sensors can be configured to capture data associated with a temperature, a pressure, a gas concentration, etc. of the environment within process chamber 214, 216, 218 during the substrate process.

In some implementations, metrology equipment (not shown) can be located within the process tool. In other implementations, metrology equipment (not shown) can be located within one or more process chambers 214, 216, 218. In some implementations, the substrate can be placed onto metrology equipment using transfer chamber robot 212. In other implementations, the metrology equipment can be part of the substrate support assembly (not shown). Metrology equipment can provide metrology data associated with substrates processed by manufacturing equipment 124. The metrology data can include a value of film property data (e.g., wafer spatial film properties), dimensions (e.g., thickness, height, etc.), dielectric constant, dopant concentration, density, defects, etc. In some implementations, the metrology data can further include a value of one or more surface profile property data (e.g., an etch rate, an etch rate uniformity, a critical dimension of one or more features included on a surface of the substrate, a critical dimension uniformity across the surface of the substrate, an edge placement error, etc.). The metrology data can be of a finished or semi-finished product. The metrology data can be different for each substrate. Metrology data can be generated using, for example, reflectometry techniques, ellipsometry techniques, TEM techniques, and so forth.

A load lock 220 can also be coupled to housing 208 and transfer chamber 210. Load lock 220 can be configured to interface with, and be coupled to, transfer chamber 210 on one side and factory interface 206. Load lock 220 can have an environmentally-controlled atmosphere that can be changed from a vacuum environment (wherein substrates can be transferred to and from transfer chamber 210) to an at or near atmospheric-pressure inert-gas environment (wherein substrates can be transferred to and from factory interface 206) in some implementations. Factory interface 206 can be any suitable enclosure, such as, e.g., an Equipment Front End Module (EFEM). Factory interface 206 can be configured to receive substrates 202 from substrate carriers 222 (e.g., Front Opening Unified Pods (FOUPs)) docked at various load ports 224 of factory interface 206. A factory interface robot 226 (shown dotted) can be configured to transfer substrates 202 between carriers (also referred to as containers) 222 and load lock 220. Carriers 222 can be a substrate storage carrier or a replacement part storage carrier.

Manufacturing system 200 can also be connected to a client device (e.g., client device 110, not shown) that is configured to provide information regarding manufacturing system 200 to a user (e.g., an operator). In some implementations, the client device can provide information to a user of manufacturing system 200 via one or more graphical user interfaces (GUIs). For example, the client device can provide information relating to which tool or operation to implement via a GUI. The client device can also provide information regarding predictive technologies in accordance with implementations described herein.

Manufacturing system 200 can also include a system controller 228. System controller 228 can be and/or include a computing device such as a personal computer, a server computer, a programmable logic controller (PLC), a microcontroller, and so on. System controller 228 can include one or more processing devices, which can be general-purpose processing devices such as a microprocessor, central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device can also be one or more special-purpose processing devices such as an application specific integrated circuit (ASIC), a field programmable gate array (FPGA), a digital signal processor (DSP), network processor, or the like. System controller 228 can include a data storage device (e.g., one or more disk drives and/or solid state drives), a main memory, a static memory, a network interface, and/or other components. System controller 228 can execute instructions to perform any one or more of the methodologies and/or implementations described herein. In some implementations, system controller 228 can execute instructions to perform one or more operations at manufacturing system 200 in accordance with a process recipe. The instructions can be stored on a computer readable storage medium, which can include the main memory, static memory, secondary storage and/or processing device (during execution of the instructions).

System controller 228 can receive data from sensors (e.g., sensors 126, now shown) included on or within various portions of manufacturing system 200 (e.g., processing chambers 214, 216, 218, transfer chamber 210, load lock 220, etc.). In some implementations, data received by the system controller 228 can include spectral data and/or non-spectral data for a portion of substrate 202. In other or similar implementations, data received by the system controller 228 can include data associated with processing substrate 202 at processing chamber 214, 216, 218, as described previously. For purposes of the present description, system controller 228 is described as receiving data from sensors included within process chambers 214, 216, 218. However, system controller 228 can receive data from any portion of manufacturing system 200 and can use data received from the portion in accordance with implementations described herein. In an illustrative example, system controller 228 can receive data from one or more sensors for process chamber 214, 216, 218 before, after, or during a substrate process at the process chamber 214, 216, 218. Data received from sensors of the various portions of manufacturing system 200 can be stored in a data store 250. Data store 250 can be included as a component within system controller 228 or can be a separate component from system controller 228. In some implementations, data store 250 can be data store 140 described with respect to FIG. 1.

FIG. 3 depicts an illustrative predictive architecture 300, according to aspects of the present disclosure. In some implementations, predictive architecture 300 include predictive system 160, network 130, and data store 310 (which can be similar to the same as data store 140). Predictive system 160 can use a model (e.g., model 190) to generate one or more modification reports, modification instructions, comparison reports, etc.

Multiple models can be generated (e.g., trained) and configured for use by application 114, predictive server 195, etc. In some implementations, each model 190 can be referred to as a “predictive subsystem”. In some implementations, predictive system 160 can include predictive server 112, server machines 170 and 180, and predictive server 195. The predictive server 160, server machine 170, server machine 180, and predictive server 195 can each include one or more computing devices such as a rackmount server, a router computer, a server computer, a personal computer, a mainframe computer, a laptop computer, a tablet computer, a desktop computer, Graphics Processing Unit (GPU), accelerator Application-Specific Integrated Circuit (ASIC) (e.g., Tensor Processing Unit (TPU)), etc.

Server machine 170 includes a training set generator 172 that is capable of generating training data sets (e.g., a set of data inputs and a set of target outputs) to train, validate, and/or test a machine learning model 190. Machine learning model 190 can be any algorithmic model capable of learning from data. In some implementations, machine learning model 190 can be a predictive model. In some implementations, the data set generator 172 can partition the training data into a training set, a validating set, and a testing set, which can be stored, as part of the training statistics 312, in the training data store 310. Training statistics 312 which can be accessible to the computing device predictive system 160 directly or via network 130. In some implementations, the predictive system 160 generates multiple sets of training data.

Server machine 180 can include a training engine 182, a validation engine 184, a selection engine 185, and/or a testing engine 186. An engine can refer to hardware (e.g., circuitry, dedicated logic, programmable logic, microcode, processing device, etc.), software (such as instructions run on a processing device, a general-purpose computer system, or a dedicated machine), firmware, microcode, or a combination thereof. Training engine 182 can be capable of training one or more machine learning model 190. Machine learning model 190 can refer to the model artifact that is created by the training engine 182 using the training data (also referred to herein as a training set) that includes training inputs and corresponding target outputs (correct answers for respective training inputs). The training engine 182 can find patterns in the training data that map the training input to the target output (the answer to be predicted), and provide the machine learning model 190 that captures these patterns. The machine learning model 190 can use one or more of a statistical modelling, support vector machine (SVM), Radial Basis Function (RBF), clustering, supervised machine learning, semi-supervised machine learning, unsupervised machine learning, k-nearest neighbor algorithm (k-NN), linear regression, random forest, neural network (e.g., artificial neural network), gradient boosted models, (e.g., models where individual trees are added in a way that maximizes their ability to reduce error), etc.

One type of machine learning model that can be used to perform some or all of the above tasks is an artificial neural network, such as a deep neural network. Artificial neural networks generally include a feature representation component with a classifier or regression layers that map features to a desired output space. A convolutional neural network (CNN), for example, hosts multiple layers of convolutional filters. Pooling is performed, and non-linearities can be addressed, at lower layers, on top of which a multi-layer perceptron is commonly appended, mapping top layer features extracted by the convolutional layers to decisions (e.g., classification outputs). Deep learning is a class of machine learning algorithms that use a cascade of multiple layers of nonlinear processing units for feature extraction and transformation. Each successive layer uses the output from the previous layer as input. Deep neural networks can learn in a supervised (e.g., classification) and/or unsupervised (e.g., pattern analysis) manner. Deep neural networks include a hierarchy of layers, where the different layers learn different levels of representations that correspond to different levels of abstraction. In deep learning, each level learns to transform its input data into a slightly more abstract and composite representation. Notably, a deep learning process can learn which features to optimally place in which level on its own. The “deep” in “deep learning” refers to the number of layers through which the data is transformed. More precisely, deep learning systems have a substantial credit assignment path (CAP) depth. The CAP is the chain of transformations from input to output. CAPs describe potentially causal connections between input and output. For a feedforward neural network, the depth of the CAPs can be that of the network and can be the number of hidden layers plus one. For recurrent neural networks, in which a signal can propagate through a layer more than once, the CAP depth is potentially unlimited.

In some implementations, one or more machine learning models can be a large language model (LLM). An LLM is a type of artificial intelligence (e.g., machine learning) model designed to understand and generate human-like text. LLMs can perform natural language processing tasks such as language translation, text summarization, question answering, etc. An LLM can be built on deep learning architectures, such as transformer models. In some implementations, an LLM can be generated through supervised learning, during which the LLM is trained on large datasets of text. The text can be gathered from various sources, such as books, articles, websites, digital libraries, and so forth. A text dataset can be used to pre-train an LLM on a language modeling task where the LLM learns to predict the next word in a sequence of text given the previous words. This pre-training phase can be used to develop, for the LLM, a deep understanding of language patterns and semantics. After pre-training, the LLM can be fine-tuned on specific tasks to specialize its capabilities. During fine-tuning, the LLM can be exposed to examples of the target task, such as text classification or language translation, corresponding labels or target outputs, etc. In some implementations, the LLM can adjust one or more parameters to minimize the difference between predictions and true outputs. The adjusting can be performed using iterative optimization techniques, such as, for example, gradient descent. The adjusting process can enable the LLM to adapt pre-learned knowledge to the nuances of the target task, making it more effective in real-world applications. In some implementations, the LLM can be used to generate one or more modification reports and/or simulation reports. This will be described in detail below.

In some implementations, one or more machine learning models can be a recurrent neural network (RNN). An RNN is a type of neural network that includes a memory to enable the neural network to capture temporal dependencies. An RNN is able to learn input-output mappings that depend on both a current input and past inputs. The RNN will address past and future flow rate measurements and make predictions based on this continuous metrology information. RNNs can be trained using a training dataset to generate a fixed number of outputs (e.g., to determine a set of substrate processing rates, determine modification to a substrate process recipe). One type of RNN that can be used is a long short term memory (LSTM) neural network.

Training of a neural network can be achieved in a supervised learning manner, which involves feeding a training dataset consisting of labeled inputs through the network, observing its outputs, defining an error (by measuring the difference between the outputs and the label values), and using techniques such as deep gradient descent and backpropagation to tune the weights of the network across all its layers and nodes such that the error is minimized. In many applications, repeating this process across the many labeled inputs in the training dataset yields a network that can produce correct output when presented with inputs that are different than the ones present in the training dataset.

A training dataset containing hundreds, thousands, tens of thousands, hundreds of thousands or more sensor data and/or process result data (e.g., metrology data such as one or more thickness profiles associated with the sensor data) can be used to form a training dataset.

To effectuate training, processing logic can input the training dataset(s) into one or more untrained machine learning models. Prior to inputting a first input into a machine learning model, the machine learning model can be initialized. Processing logic trains the untrained machine learning model(s) based on the training dataset(s) to generate one or more trained machine learning models that perform various operations as set forth above.

The machine learning model processes the input to generate an output. An artificial neural network includes an input layer that consists of values in a data point. The next layer is called a hidden layer, and nodes at the hidden layer each receive one or more of the input values. Each node contains parameters (e.g., weights) to apply to the input values. Each node therefore essentially inputs the input values into a multivariate function (e.g., a non-linear mathematical transformation) to produce an output value. A next layer can be another hidden layer or an output layer. In either case, the nodes at the next layer receive the output values from the nodes at the previous layer, and each node applies weights to those values and then generates its own output value. This can be performed at each layer. A final layer is the output layer, where there is one node for each class, prediction and/or output that the machine learning model can produce.

Accordingly, the output can include one or more predictions or inferences. In some implementations, an output prediction or inference can include one or more predictions relating to a simulation report, modification instructions, comparison data, etc. Processing logic determines an error (i.e., a classification error) based on the differences between the output (e.g., predictions or inferences) of the machine learning model and target labels associated with the input training data. Processing logic adjusts weights of one or more nodes in the machine learning model based on the error. An error term or delta can be determined for each node in the artificial neural network. Based on this error, the artificial neural network adjusts one or more of its parameters for one or more of its nodes (the weights for one or more inputs of a node). Parameters can be updated in a back propagation manner, such that nodes at a highest layer are updated first, followed by nodes at a next layer, and so on. An artificial neural network contains multiple layers of “neurons”, where each layer receives as input values from neurons at a previous layer. The parameters for each neuron include weights associated with the values that are received from each of the neurons at a previous layer. Accordingly, adjusting the parameters can include adjusting the weights assigned to each of the inputs for one or more neurons at one or more layers in the artificial neural network.

After one or more rounds of training, processing logic can determine whether a stopping criterion has been met. A stopping criterion can be a target level of accuracy, a target number of processed images from the training dataset, a target amount of change to parameters over one or more previous data points, a combination thereof and/or other criteria. In one implementation, the stopping criteria is met when at least a minimum number of data points have been processed and at least a threshold accuracy is achieved. The threshold accuracy can be, for example, 70%, 80% or 90% accuracy. In one implementation, the stopping criterion is met if accuracy of the machine learning model has stopped improving. If the stopping criterion has not been met, further training is performed. If the stopping criterion has been met, training can be complete. Once the machine learning model is trained, a reserved portion of the training dataset can be used to test the model.

Once one or more trained machine learning models 190 are generated, they can be stored in predictive server 195 as predictive component 197 or as a component of predictive component 197.

The validation engine 184 can be capable of validating machine learning model 190 using a corresponding set of features of a validation set from training set generator 172. Once the model parameters have been optimized, model validation can be performed to determine whether the model has improved and to determine a current accuracy of the deep learning model. The validation engine 184 can determine an accuracy of machine learning model 190 based on the corresponding sets of features of the validation set. The validation engine 184 can discard a trained machine learning model 190 that has an accuracy that does not meet a threshold accuracy. In some implementations, the selection engine 185 can be capable of selecting a trained machine learning model 190 that has an accuracy that meets a threshold accuracy. In some implementations, the selection engine 185 can be capable of selecting the trained machine learning model 190 that has the highest accuracy of the trained machine learning models 190.

The testing engine 186 can be capable of testing a trained machine learning model 190 using a corresponding set of features of a testing set from data set generator 172. For example, a first trained machine learning model 190 that was trained using a first set of features of the training set can be tested using the first set of features of the testing set. The testing engine 186 can determine a trained machine learning model 190 that has the highest accuracy of all of the trained machine learning models based on the testing sets.

As described in detail below, predictive server 195 includes a predictive component 197 that is capable of providing diagnostic reports and/or knowledge-based reports that include predictive data reflect issue data (e.g., root cause data), corrective action data, etc. and running trained machine learning model 190 on data items such as input prompts to obtain one or more outputs.

It should be noted that in some other implementations, the functions of server machines 170 and 180, as well as predictive server 195, can be provided by a fewer number of machines. For example, in some implementations, server machines 170 and 180 can be integrated into a single machine, while in some other or similar implementations, server machines 170 and 180, as well as predictive server 195, can be integrated into a single machine.

In general, functions described in one implementation as being performed by server machine 170, server machine 180, and/or predictive server 195 can also be performed on client device 110. In addition, the functionality attributed to a particular component can be performed by different or multiple components operating together.

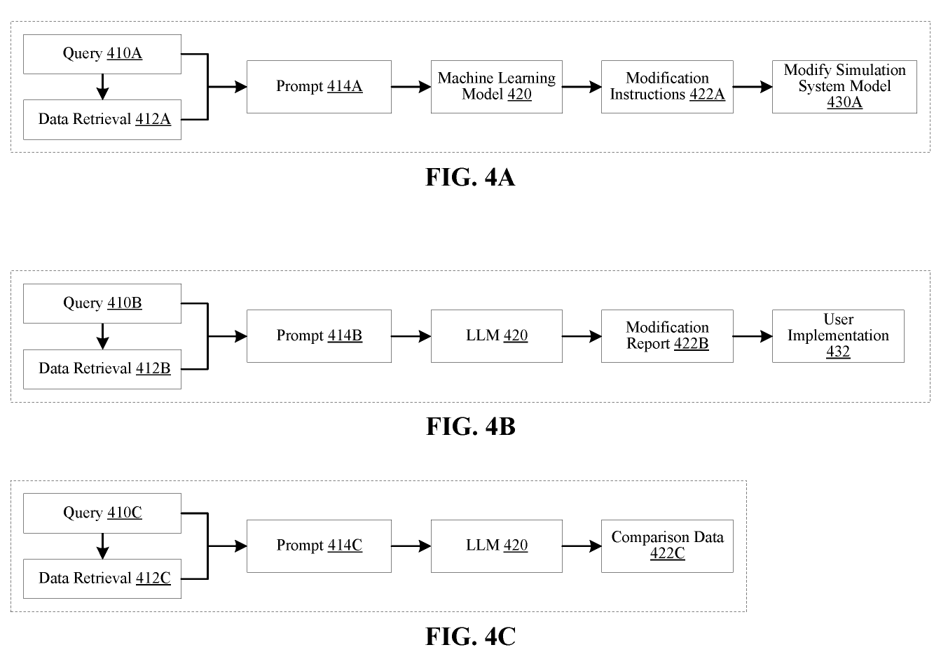

FIGS. 4A-4C are diagrams of frameworks for applying a machine learning model to generate predictive data, in accordance with some implementations of the present disclosure. In particular, FIG. 4A is a diagram for applying a machine learning model to generate modification instructions, FIG. 4B is a diagram for applying a machine learning model to generate a modification report, and FIG. 4C is a diagram for applying a machine learning model to generate comparison data.

In FIG. 4A, query 410A is generated by a user via a user interface (e.g., user interface 112). Query 410A can include a request for a machine learning model (e.g., an LLM) to generate modification instructions (e.g., computer code) to modify a model of simulation system 170 (e.g., simulation model 172, planning model 174, etc.) and/or instructions to modify one or more structures 176A-176N. In an illustrative example relating to simulation model 172, query 410 can state; “create a scenario where the preventive maintenance for process chamber A is moved from date A to date B,” “create a scenario where process chamber B is qualified to process step A of process recipe A,” etc. In an illustrative example relating to planning model 174, query 410 can state; “create a scenario where demand for part A increases by 10%,” “create a scenario where production ceases for part B in the second quarter of year A,” etc. Once the query(ies) is received, application 114 can perform data retrieval 412A to retrieve relevant data such as, for example, one or more structures 176A-176N, dispatching rules 151, state data 153, user data 155, etc. In some implementations, application 114 can retrieve all of structures 176A-176N. In other implementations, application 114 can retrieve only the data structures relevant to the query 410A. To retrieve relevant data structures, application 114 can perform a filtering operation, such as, for example, using a relevant neural network model configured to compare the query for relevance against the text description of data structures 176A-176N and/or against the text description of the columns or rows of data structures 176A-176N. Once compared, only a set of relevant data structures are forwarded to prompt 414A.

Prompt 414A can be automatically generated by, for example, inserting the questions (or statements) of query 410A and the data from data retrieval 412A into a predetermined format. In some implementations, prompt 414A can be structured to ask, from a machine learning model, one or more specific questions related to one or more data structures 176A-176N. In some implementations, prompt 414A can further include one or more of a task(s), an instruction(s), a desired format, etc.

Prompt 414A can be provided, as input, to machine learning model 420. In some implementations, machine learning model 420 be an LLM or any other type of machine language model trained to perform natural language processing tasks, such as those described with reference to model 190. In some implementations, machine learning model 420 can be trained as discussed in relation to training model 190. In some implementations, prompt 414A can be provide along with data referencing one or more data structures 176A-176N.

In some implementations, machine learning model 420 can be supported by a prompt subsystem used to provide the prompt (and the retrieved data from data retrieval 412A-412C, discussed below) to the machine learning model 420. The prompt sub-system can be a part of application 114, of machine learning model 420, etc. The prompt subsystem can enable access to machine learning model 420. The prompt subsystem can be configured to perform automated identification of, and facilitate retrieval of, relevant and timely contextual information for efficient and accurate processing of prompts by machine learning model 420. Using network 130 (or another network), the prompt subsystem can be in communication with one or more of client device 110, manufacturing equipment 124, data store 140, 150, predictive system 160, simulation system 170, etc. In some implementations, communications between the prompt subsystem and machine learning model 420 can be facilitated by an application programming interface (API). In some implementations, the API translates prompts generated by the prompt subsystem into unstructured natural-language format and, conversely, translates responses received from machine learning model 420 into any suitable form (e.g., including any structured proprietary format as may be used by the prompt subsystem). Similarly, the API can support instructions that can be used to communicate data requests to client device 110, manufacturing equipment 124, data store 140, 150, predictive system 160, and/or simulation system 170, and formats of data received from such components.

The prompt subsystem can include (or can have access to) instructions stored on one or more tangible, machine-readable storage media of a computing device (e.g., the client device 110, predictive system 160, and/or simulation system 170) and executable by one or more processing devices of the computing device. In some implementations, the prompt subsystem is implemented on a single machine. In some implementations, the prompt subsystem is a combination of a client component and a server component. In some implementations, the prompt subsystem is executed entirely on the predictive system (e.g., executed automatically). Alternatively, some portion (or all of) of the prompt subsystem can be executed on a client device 110, while another portion of the prompt subsystem can be executed on a different component (e.g., predictive system 160).

Machine learning model 420 can generate, as output, modification instructions 422A. Modification instructions 422A can include, for example, computer code to modify one or more data structures 176A-176N to produce a desired scenario, instructions to modify one or more of simulation model 1725, planning model 174, etc. In an illustrative example, the modification instructions can include code to obtain a specific data frame from an object, filter the data frame to only include an order for a certain process chamber, and update certain corresponding due dates. Application 114 can then modify simulation system model 430A (e.g., simulation model 172 and/or planning model 174) and/or the relevant data structures using the modification instructions 422A to generate the desired scenario.

In FIG. 4B, query 410B is generated by a user via a user interface (e.g., user interface 112). Query 410B can include a request for a machine learning model (e.g., an LLM) to generate a modification report that include data reflecting one or more steps describing how to modify one or more data structures 176A-176N to produce a desired scenario via simulation model 172 and/or planning model 174. Once the query(ies) is received, application 114 can perform data retrieval 412B to retrieve relevant data such as, for example, one or more data structures 176A-176N, dispatching rules 151, state data 153, user data 155, etc. In some implementations, application 114 can retrieve all of data structures 176A-176N. In other implementations, application 114 can retrieve only the data structures relevant to the query 410B using, for example, a filtering operation.

Prompt 414B can be automatically generated by, for example, inserting the questions (or statements) of query 410B and the data from data retrieval 412B into a predetermined format. In some implementations, prompt 414B can be structured to ask, from a machine learning model, one or more specific questions related to one or more data structures 176A-176N. In some implementations, prompt 414B can further include one or more of a task(s), an instruction(s), a desired format, etc.

Prompt 414B can be provided, as input, to machine learning model 420. In some implementations, prompt 414B can be provide along with data referencing one or more data structures 176A-176N.

Machine learning model 420 can generate, as output, a modification report 422B. Modification report 422B can include, for example, instructions indicating which records of which data structures 176A-176N to modify to produce the desired scenario. In an illustrative example, the modification report can include the data structure identifiers (e.g., table identifiers) and corresponding columns, rows, and/or records to obtain a specific scenario from simulation model 172 and/or planning model 174. The user can then, via user input, manually modify the appropriate records and request a simulation via predictive component 178.

In FIG. 4C, query 410C is generated by a user via a user interface (e.g., user interface 112). Query 410C can include a request for a machine learning model (e.g., an LLM) to generate comparison data (e.g., a graph or a chart illustrating comparisons or differences between two or more scenarios and/or the current task schedule). Once the query(ies) is received, application 114 can perform data retrieval 412C to retrieve relevant data such as, for example, one or more data structures 176A-176N, dispatching rules 151, state data 153, user data 155, one or more scenarios generated via simulation model 172 and/or planning model 174, etc. In some implementations, application 114 can retrieve all of data structures 176A-176N. In other implementations, application 114 can retrieve only the data structures relevant to the query 410C using, for example, a filtering operation.

Prompt 414C can be automatically generated by, for example, inserting the questions (or statements) of query 410C and the data from data retrieval 412C into a predetermined format. In some implementations, prompt 414C can be structured to ask, from a machine learning model, one or more specific questions related to one or more data structures 176A-176N. In some implementations, prompt 414C can further include one or more of a task(s), an instruction(s), a desired format, etc.

Prompt 414C can be provided, as input, to machine learning model 420. In some implementations, prompt 414C can be provided along with data referencing one or more data structures 176A-176N and/or one or more scenarios. Machine learning model 420 can generate, as output, comparison data 422C. The comparison data can include graph or a chart illustrating comparisons or differences between two or more scenarios and/or the current task schedule. In some implementations, the output can include a comparison report that include steps describing how to produce a desired graph, chart, or table.

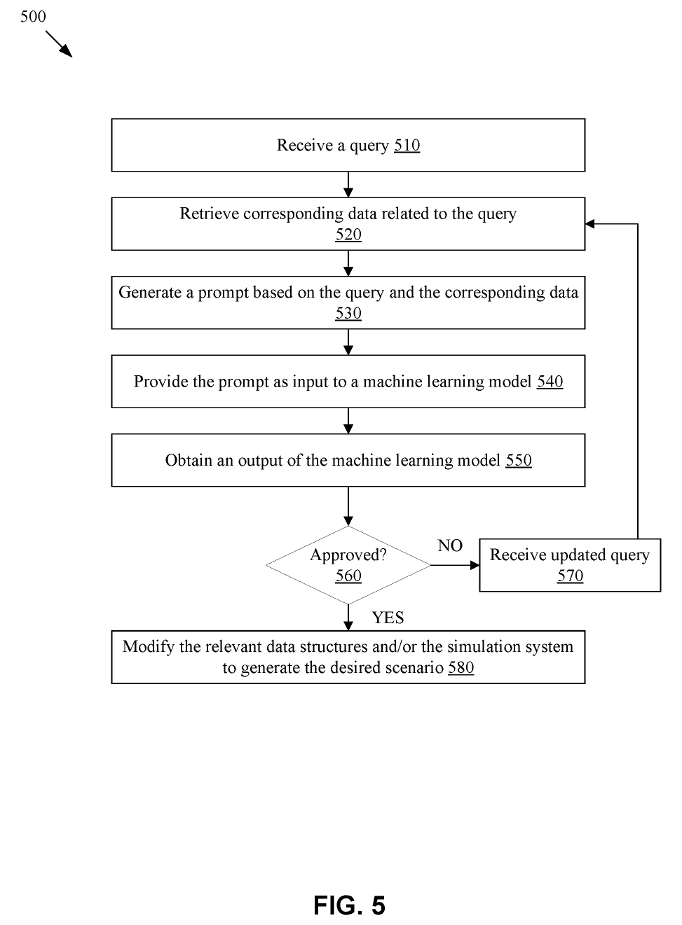

FIG. 5 is a flow diagram of method 500 for applying a machine learning model to generate predictive data, in accordance with some implementations of the present disclosure. In some implementations, method 500 is performed by processing logic that includes hardware (e.g., circuitry, dedicated logic, programmable logic, microcode, processing device, etc.), software (such as instructions run on a processing device, a general-purpose computer system, or a dedicated machine), firmware, microcode, or a combination thereof. In some implementations, method 500 is performed, at least in part, by predictive system 160, simulation system 170, and/or client device 110. In some implementations, a non-transitory storage medium stores instructions that when executed by a processing device (e.g., of predictive system 160, of predictive server 195, etc.) cause the processing device to perform one or more of method 500.

For simplicity of explanation, method 500 is depicted and described as a series of operations. However, operations in accordance with this disclosure can occur in various orders and/or concurrently and with other operations not presented and described herein. Furthermore, in some implementations, not all illustrated operations are performed to implement method 500 in accordance with the disclosed subject matter. In addition, those skilled in the art will understand and appreciate that method 500 could alternatively be represented as a series of interrelated states via a state diagram or events.

At operation 510, the processing logic receives a query. The query can include one or more questions or statements related to a production scenario. In some implementations, the query can be received via a user interface.

At operation 520, the processing logic retrieves corresponding data related to the query. The corresponding data can include, for example, one or more data structures 176A-176N, dispatching rules 151, state data 153, user data 155, etc. In some implementations, the processing logic can retrieve all of data structures 176A-176N. In other implementations, the processing logic can retrieve only the data structures relevant to the query. To retrieve the relevant data structures, the processing logic can perform a filtering operation.

At operation 530, the processing logic generates a prompt based on the query and the corresponding data. The processing logic can generate the prompt automatically by, for example, inserting the questions and/or statements of the query and the corresponding data into a predetermined format.

At operation 540, the processing logic provides the prompt as input to a machine learning model. The machine learning model can be, for example, an LLM. In some implementations, the prompt and the data structures can be provided as input separately.

At operation 550, the processing logic obtains an output of the machine learning model. The output of the machine learning model can include a modification report, modification instructions, a comparison report, etc.

At operation 560, the processing logic can provide the output for approval. For example, the processing logic can send the modification report, modification instructions and/or comparison report to application 114 of client device 110. Responsive to failing to receive approval (e.g., user input approving the results), the processing logic can proceed to operation 570 and receive an updated query. For example, the update query can include one or more new questions or statements, a revised query, etc. The processing logic can then proceed to operation 520.

In implementations where the output includes a modification report and/or a comparison report, responsive to receiving approval, the user can then, via user input, manually modify the appropriate records and request a simulation via predictive component 178. In implementations where the output includes modification instructions, the processing logic proceeds to operation 580 and modifies the relevant data structures and/or the simulation system (e.g., simulation model 172 and/or planning model 174) to generate the desired scenario. In some implementations, the processing logic can proceed from operation 550 to operation 570 without the need for obtaining approval.

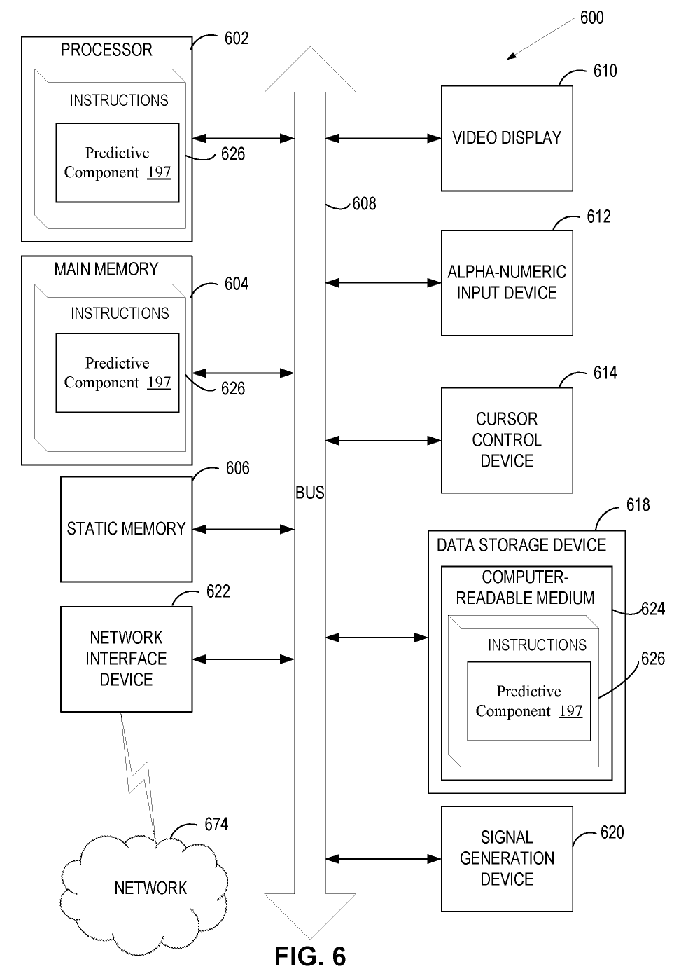

FIG. 6 is a block diagram illustrating a computer system 600, according to certain implementations. In some implementations, computer system 600 can be connected (e.g., via a network, such as a Local Area Network (LAN), an intranet, an extranet, or the Internet) to other computer systems. Computer system 600 can operate in the capacity of a server or a client computer in a client-server environment, or as a peer computer in a peer-to-peer or distributed network environment. Computer system 600 can be provided by a personal computer (PC), a tablet PC, a Set-Top Box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term "computer" shall include any collection of computers that individually or jointly execute a set (or multiple sets) of instructions to perform any one or more of the methods described herein.

In a further aspect, the computer system 600 can include a processing device 602, a volatile memory 604 (e.g., Random Access Memory (RAM)), a non-volatile memory 606 (e.g., Read-Only Memory (ROM) or Electrically-Erasable Programmable ROM (EEPROM)), and a data storage device 616, which can communicate with each other via a bus 608.

Processing device 602 can be provided by one or more processors such as a general purpose processor (such as, for example, a Complex Instruction Set Computing (CISC) microprocessor, a Reduced Instruction Set Computing (RISC) microprocessor, a Very Long Instruction Word (VLIW) microprocessor, a microprocessor implementing other types of instruction sets, or a microprocessor implementing a combination of types of instruction sets) or a specialized processor (such as, for example, an Application Specific Integrated Circuit (ASIC), a Field Programmable Gate Array (FPGA), a Digital Signal Processor (DSP), or a network processor).

Computer system 600 can further include a network interface device 622 (e.g., coupled to network 674). Computer system 600 also can include a video display unit 610 (e.g., an LCD), an alphanumeric input device 612 (e.g., a keyboard), a cursor control device 614 (e.g., a mouse), and a signal generation device 620.

In some implementations, data storage device 616 can include a non-transitory computer-readable storage medium 624 on which can store instructions 626 encoding any one or more of the methods or functions described herein, including instructions encoding components of FIG. 1 (e.g., predictive component 197, application 114, etc.) and for implementing methods described herein.

Instructions 626 can also reside, completely or partially, within volatile memory 604 and/or within processing device 602 during execution thereof by computer system 600, hence, volatile memory 604 and processing device 602 can also constitute machine-readable storage media.

While computer-readable storage medium 624 is shown in the illustrative examples as a single medium, the term "computer-readable storage medium" shall include a single medium or multiple media (e.g., a centralized or distributed database, and/or associated caches and servers) that store the one or more sets of executable instructions. The term "computer-readable storage medium" shall also include any tangible medium that is capable of storing or encoding a set of instructions for execution by a computer that cause the computer to perform any one or more of the methods described herein. The term "computer-readable storage medium" shall include, but not be limited to, solid-state memories, optical media, and magnetic media.

The methods, components, and features described herein can be implemented by discrete hardware components or can be integrated in the functionality of other hardware components such as ASICS, FPGAs, DSPs or similar devices. In addition, the methods, components, and features can be implemented by firmware modules or functional circuitry within hardware devices. Further, the methods, components, and features can be implemented in any combination of hardware devices and computer program components, or in computer programs.

Unless specifically stated otherwise, terms such as “receiving,” “performing,” “providing,” “obtaining,” “causing,” “accessing,” “determining,” “adding,” “using,” “training,” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms "first," "second," "third," "fourth," etc. as used herein are meant as labels to distinguish among different elements and cannot have an ordinal meaning according to their numerical designation.

Examples described herein also relate to an apparatus for performing the methods described herein. This apparatus can be specially constructed for performing the methods described herein, or it can include a general purpose computer system selectively programmed by a computer program stored in the computer system. Such a computer program can be stored in a computer-readable tangible storage medium.

The methods and illustrative examples described herein are not inherently related to any particular computer or other apparatus. Various general purpose systems can be used in accordance with the teachings described herein, or it can prove convenient to construct more specialized apparatus to perform methods described herein and/or each of their individual functions, routines, subroutines, or operations. Examples of the structure for a variety of these systems are set forth in the description above.

The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

In the claims:

1. A method, comprising:
receiving, by a processing device, a query related to a desired production scenario of a substrate fabrication facility;
generating a prompt based on the query, wherein the prompt comprises data related to the query and data related to one or more data structures used by a production model to generate production scenario options;
providing the prompt as input to a trained machine learning model; and
obtaining an output of the trained machine learning model, the output comprising modification data associated with the one or more data structures to be used by the production model to generate the desired production scenario.

2. The method of claim 1, further comprising:
automatically updating the one or more data structures based on the modification data; and
generating, via the production model, the desired production scenario based on the updated one or more data structures.

3. The method of claim 1, wherein the machine learning model is a large language model (LLM).

4. The method of claim 1, further comprising:
generating a report based on the output; and
providing the report to a client device.

5. The method of claim 1, wherein the output further comprises comparison data comparing one or more aspects of the desired production scenario to one or more aspects of a scheduled production.

6. The method of claim 1, wherein the output further comprises comparison data comparing one or more aspects of the desired production scenario to one or more aspects of another production scenario.

7. The method of claim 1, further comprising:
responsive to receiving user input rejecting the output, obtaining an updated query.

8. The method of claim 1, further comprising:
performing a filtering operation to select a subset of data structures from the one or more data structures; and
providing the subset to the prompt.

9. A system, comprising:
a memory device; and
a processing device, operatively coupled to the memory device, to perform operations comprising:
receiving a query related to a desired production scenario of a substrate fabrication facility;
generating a prompt based on the query, wherein the prompt comprises data related to the query and data related to one or more data structures used by a production model to generate production scenario options;
providing the prompt as input to a trained machine learning model; and
obtaining an output of the trained machine learning model, the output comprising modification data associated with the one or more data structures to be used by the production model to generate the desired production scenario.

10. The system of claim 9, wherein the operations further comprise:
automatically updating the one or more data structures based on the modification data; and
generating, via the production model, the desired production scenario based on the updated one or more data structures.

11. The system of claim 9, wherein the machine learning model is a large language model (LLM).

12. The system of claim 9, wherein the operations further comprise:
generating a report based on the output; and
providing the report to a client device.

13. The system of claim 9, wherein the output further comprises comparison data comparing one or more aspects of the production scenario to one or more aspects of a scheduled production.

14. The system of claim 9, wherein the output further comprises comparison data comparing one or more aspects of the production scenario to one or more aspects of another production scenario.

15. The system of claim 9, wherein the operations further comprise:
responsive to receiving user input rejecting the output, obtaining an updated query.

16. The system of claim 9, wherein the operations further comprise:
performing a filtering operation to select a subset of data structures from the one or more data structures; and
providing the subset to the prompt.

17. A non-transitory computer-readable storage medium comprising instructions that, when executed by a processing device operatively coupled to a memory, performs operations comprising:
receiving a query related to a desired production scenario of a substrate fabrication facility;
generating a prompt based on the query, wherein the prompt comprises data related to the query and data related to one or more data structures used by a production model to generate production scenario options;
providing the prompt as input to a trained machine learning model; and
obtaining an output of the trained machine learning model, the output comprising modification data associated with the one or more data structures to be used by the production model to generate the desired production scenario.

18. The non-transitory computer-readable storage medium of claim 17, wherein the operations further comprise:
automatically updating the one or more data structures based on the modification data; and
generating, via the production model, the desired production scenario based on the updated one or more data structures.

19. The non-transitory computer-readable storage medium of claim 17, wherein the operations further comprise:
generating a report based on the output; and
providing the report to a client device.

20. The non-transitory computer-readable storage medium of claim 17, wherein the output further comprises comparison data comparing one or more aspects of the production scenario to one or more aspects of a scheduled production.
